(19) United States
(12) Patent Application Publication
(10) Pub. No.: US 2026/0105022 A1
(43) Pub. Date: Apr. 16, 2026

(54) DISTRIBUTED PROCESSING APPARATUS AND OPERATING METHOD THEREOF

(71) Applicant: Samsung Electronics Co., Ltd., Suwon-si (KR)

(72) Inventors: Hyeonuk SIM, Suwon-si (KR); Mun Gyu Son, Suwon-si (KR)

(73) Assignee: SAMSUNG ELECTRONICS CO., LTD., Suwon-si (KR)

(21) Appl. No.: 19/173,390

(22) Filed: Apr. 8, 2025

(30) Foreign Application Priority Data
Oct. 15, 2024 (KR) 10-2024-0140395

(51) Int. Cl. G06F 15/173; G06F 15/177

(52) U.S. Cl. CPC G06F 15/17381; G06F 15/177

(57) ABSTRACT

A distributed processing apparatus and an operating method thereof are provided. The distributed processing apparatus includes operation nodes grouped into first groups, first tree nodes configured to connect operation nodes belonging to each of the plurality of first groups; and additional nodes configured to connect root nodes of the first groups. In a first tree structure including the plurality of first additional nodes and the plurality of first tree nodes, a first intermediate node is configured to perform a reduction operation on data received from child nodes in the first tree structure, and control a data flow of a result of the reduction operation within the first tree structure, according to a first target height received from the child nodes in the first tree structure.

### CROSS-REFERENCE TO RELATED APPLICATION

This application is based on and claims priority from Korean Patent Application No. 10-2024-0140395, filed on Oct. 15, 2024, in the Korean Intellectual Property Office, the entire disclosure of which is incorporated herein by reference for all purposes.

### BACKGROUND

### 1. Field

The disclosure relates to a distributed processing apparatus and an operating method of the distributed processing apparatus.

### 2. Description of the Related Art

A large-scale distributed system for processing large workloads has a plurality of chips or a plurality of nodes connected to each other with interconnects of various configurations. For example, a ring structure is a circular structure in which nodes are connected sequentially and data is transmitted in one direction with each node passing the data to a next node. A mesh structure is a structure in which all nodes are directly connected to other nodes and data may be exchanged through multiple paths between nodes.

In related art distributed computing systems, all-reduce operation is one of the important set operations and refers to a process of processing data distributed across multiple nodes in parallel, combining the results, and sharing the results again across all nodes. The all-reduce operation may be used in high-performance computing, distributed deep learning training, and data analysis. One of the aspects of the all-reduce operation is to share a partial result calculated at each node with other nodes to obtain a final result.

For example, in distributed deep learning, the all-reduce operation may be used when gradient values calculated by multiple graphics processing units (GPUs) are combined and the results are shared among all GPUs to use model updates equally.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a distributed processing apparatus including: a plurality of operation nodes grouped into a plurality of first groups; a plurality of first tree nodes configured to connect operation nodes, among the plurality of operation nodes, belonging to each of the plurality of first groups; and a plurality of first additional nodes configured to connect root nodes of the plurality of first groups, wherein, in a first tree structure comprising the plurality of first additional nodes and the plurality of first tree nodes, a first intermediate node is configured to: perform a reduction operation on data received from child nodes in the first tree structure, and control a data flow of a result of the reduction operation within the first tree structure, according to a first target height received from the child nodes in the first tree structure.

The reduction operation may include at least one of an arithmetic operation, a statistical operation, a count operation, or a logical operation, according to data precision and a data type.

Based on the first target height being greater than a height of the first intermediate node in the first tree structure, the first intermediate node may be configured to transmit the result of the reduction operation to a parent node in the first tree structure and broadcast data received from the parent node to the child nodes in the first tree structure.

Based on the first target height being less than or equal to a height of the first intermediate node in the first tree structure, the first intermediate node may be configured to broadcast the result of the reduction operation to the child nodes in the first tree structure.

The plurality of operation nodes may be grouped into a plurality of second groups, and the distributed processing apparatus further include: a plurality of second tree nodes configured to connect operation nodes, the plurality of operation nodes, belonging to each of the plurality of second groups.

The plurality of first groups may be configured based on grouping the plurality of operation nodes in a first direction, and the plurality of second groups are configured based on grouping the plurality of operation nodes in a second direction orthogonal to the first direction.

Each of the plurality of operation nodes may be configured to transmit data to the plurality of first tree nodes through a 2-to-1 connection switch.

The distributed processing apparatus may further include a plurality of second additional nodes configured to connect root nodes of the plurality of second groups, wherein, in a second tree structure comprising the plurality of second additional nodes and the plurality of second tree nodes, a second intermediate node is configured to: perform a reduction operation on data received from child nodes in the second tree structure, and control a data flow of a result of the reduction operation within the second tree structure, according to a second target height received from the child nodes in the second tree structure.

The first tree structure and the second tree structure may have independent connection structures.

According to another aspect of the disclosure, there is provided a distributed processing method of a distributed processing apparatus, the distributed processing method including: receiving pieces of data from each of a plurality of child nodes in a first tree structure; performing a reduction operation on the pieces of data received from the plurality of child nodes; and controlling a data flow of a result of the reduction operation within a first tree structure based on a target height corresponding to the reduction operation, wherein the first tree structure may include: a plurality of tree nodes configured to connect a plurality of nodes belonging to each of a plurality of groups, in which a plurality of operation nodes of the distributed processing apparatus is grouped, in a second tree structure; and additional nodes configured to connect root nodes among the plurality of tree nodes in a third tree structure.

The controlling of the data flow of the result of the reduction operation within the first tree structure may include transmitting the result of the reduction operation to one of the plurality of child nodes or a parent node, based on the target height.

The receiving of the pieces of data from each of the plurality of child nodes may include receiving an operation result of each of the plurality of child nodes and the target height.

According to another aspect of the disclosure, there is provided a non-transitory computer-readable storage medium storing instructions that, when executed by a processor, cause the processor to perform a method of a distributed processing apparatus including: receiving pieces of data from each of a plurality of child nodes in a first tree structure; performing a reduction operation on the pieces of data received from the plurality of child nodes; and controlling a data flow of a result of the reduction operation within a first tree structure based on a target height corresponding to the reduction operation, wherein the first tree structure may include: a plurality of tree nodes configured to connect a plurality of nodes belonging to each of a plurality of groups, in which a plurality of operation nodes of the distributed processing apparatus is grouped, in a second tree structure; and additional nodes configured to connect root nodes among the plurality of tree nodes in a third tree structure.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a diagram illustrating a connection structure of nodes according to an embodiment;

FIG. 2 is a diagram illustrating a connection structure of nodes in a mesh-of-tree (MoT), according to an embodiment;

FIG. 3 is a diagram illustrating an operation node structure according to an embodiment;

FIG. 4 is a diagram illustrating a structure of an additional node included in a tree, according to an embodiment;

FIG. 5 is a diagram illustrating a structure of an uppermost node among additional nodes, according to an embodiment;

FIG. 6 is a diagram illustrating an expanded form of a connection structure, according to an embodiment;

FIG. 7 is a flowchart illustrating a distributed processing method in a distributed processing apparatus, according to an embodiment;

FIGS. 8 to 11 are diagrams illustrating examples of communication paths in a distributed processing apparatus, according to an embodiment;

FIG. 12 is a block diagram illustrating a node of a distributed processing apparatus, according to an embodiment; and

FIG. 13 illustrates an example of an application to a hierarchical structure, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached”to the components.

The embodiments of the disclosure are example embodiments, and thus, the disclosure is not limited thereto, and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

The same name may be used to describe an element included in the embodiments described above and an element having a common function. Unless otherwise mentioned, the descriptions on the embodiments may be applicable to the following embodiments and thus, duplicated descriptions will be omitted for conciseness.

Hereinafter, according to an aspect of the disclosure, there is provided an efficient structure for processing a collective communication algorithm of a distributed processing apparatus. According to an embodiment, collective communication algorithms may include, but is not limited to, a broadcast operation, a reduce operation, a reduce-scatter operation, an all-gather operation, and an all-reduce operation. According to an embodiment, reduce-scatter and all-gather may be the start point and the end point of reduce and broadcast, respectively, expanded to all nodes, and all-reduce may be a combination of reduce-scatter and all-gather. According to an embodiment, in all cases, broadcast and reduce are basic communication elements. A tree structure for this collective communication is an optimized connection structure.

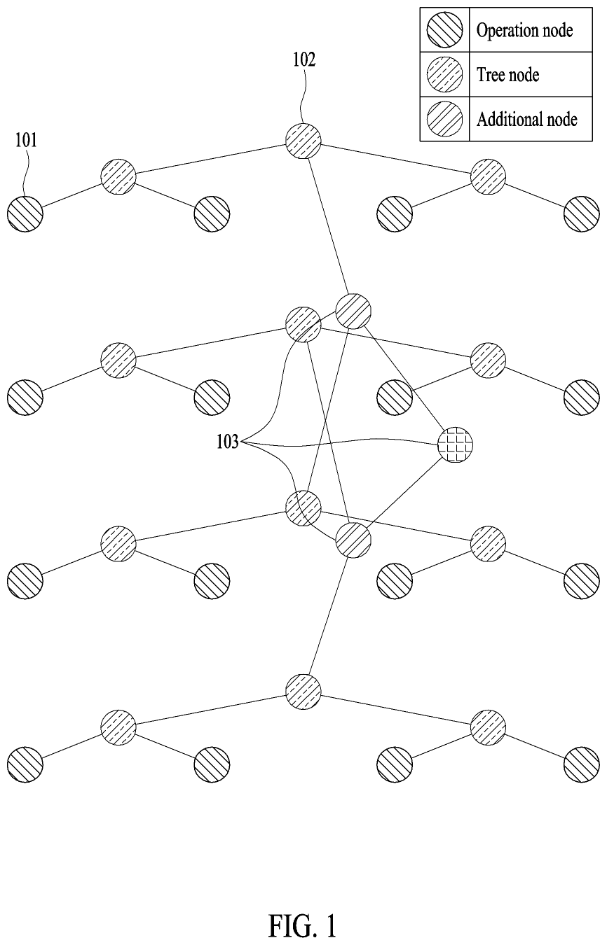

FIG. 1 is a diagram illustrating a connection structure of nodes according to an embodiment.

FIG. 1 is a structure in which nodes are connected to enable broadcast and all-reduce in a distributed processing apparatus including a plurality of one-dimensional tree structures.

In a large-scale distributed system for processing large-scale workloads, a plurality of chips or nodes may be connected with interconnects of various configurations. According to an embodiment shown in FIG. 1, the large-scale distributed system may provide a connection structure that optimizes communication time between nodes with a connection cost of small complexity. According to an embodiment, the large-scale distributed system may include, but is not limited to, operation nodes 101, tree nodes 102 and additional nodes 103.

According to an embodiment, each operation node 101 in charge of an operation may form a tree structure with adjacent nodes of a same group. For example, the nodes of the same group may be nodes included in the same row as illustrated in FIG. 1.

The distributed processing apparatus may include a plurality of groups, and the operation nodes 101 belonging to each group may form a tree structure with tree nodes 102.

Root nodes belonging to each group may be connected to additional nodes 103 in the form of a tree structure. Through this connection method, a distributed processing apparatus for performing reduction and broadcasting on data from all operation nodes 101 within the distributed processing apparatus may be provided. Reduction may include at least one of an arithmetic operation, a statistical operation, a counting operation, or a logical operation, according to data precision and data type.

In an example case in which the additional nodes 103 are connected, the tree structure may be connected in an interleaving method of connecting the root nodes, which are spaced apart from each other.

As shown in FIG. 1, communication time between the nodes may be reduced with a connection cost of small complexity through the connection structure using the additional nodes 103.

According to another embodiment, a structure may be expressed in which nodes belonging to the same column are grouped into one group, each node is connected in a tree structure, and root nodes of each tree structure are connected in a tree structure of an interleaving method.

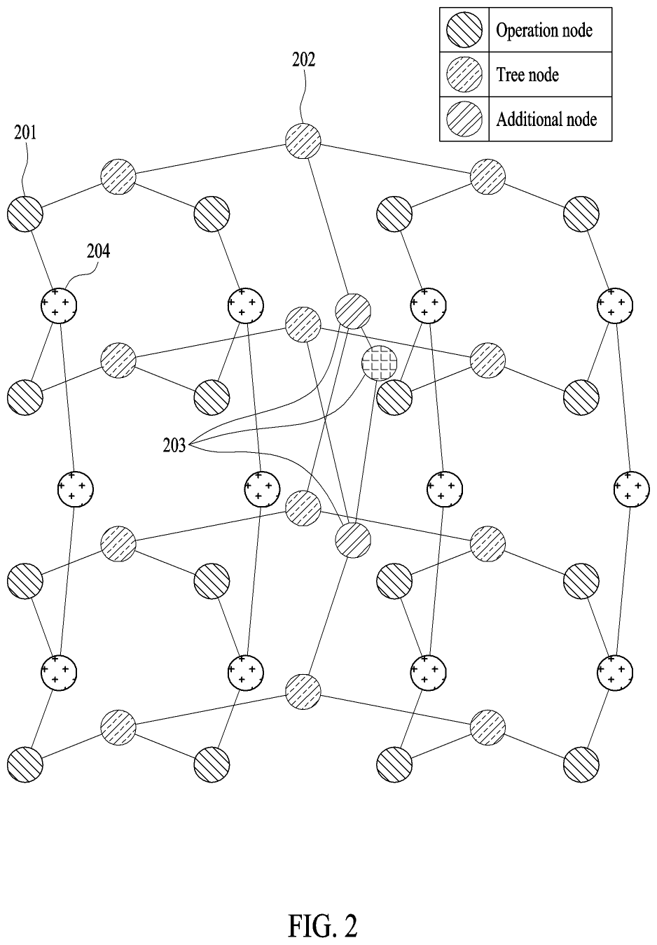

FIG. 2 is a diagram illustrating a connection structure of nodes in a mesh-of-tree (MoT), according to an embodiment.

In relation to a connection structure of a distributed processing apparatus, a mesh structure may flexibly support various configurations to process various parallelization methods in large-scale operation processing. An MoT structure may process several particular algorithms and may include connections between operation nodes and tree nodes. According to an embodiment illustrated in FIG. 2, the MoT structure may include operation nodes 201, first tree nodes 202, second three nodes 204, and additional nodes 203. For example, the operation nodes 201 may be referred to as basic nodes, the first tree nodes 202 may be referred to as horizontal tree nodes or row tree nodes, and the second tree nodes 204 may be referred to as vertical tree nodes or column tree nodes.

Compared to FIG. 1, the structure in FIG. 2 may be in a two-dimensional configuration to optimally connect multiple workloads simultaneously.

In the two-dimensional configuration, each operation node 201 may perform collective communication operations with each group while belonging to two distributed dimensions. For example, the operation nodes 201 may form one group with the first tree nodes 202 connecting groups in a row direction and may form another group in a direction orthogonal to the group in the row direction with second tree nodes 204 connecting groups in a column direction. However, the disclosure is not limited to a two-dimensional configuration. As such, according to another embodiment, the operation nodes 201 may form additional groups with the additional tree nodes.

FIG. 2 shows a connection structure that reduces and broadcasts data of all operation nodes 201 in the distributed processing apparatus by connecting, to the additional nodes 203, root nodes of the first tree nodes 202 that connect the operation nodes 201 in the two-dimensional MoT structure.

In the distributed processing apparatus having the connection structure of FIG. 2, a height at which collective communication is performed may be set according to the size of an operation. The height of each node may be determined based on a tree structure. For example, referring to FIG. 2, the lowest operation nodes 201 have a height of 0, the tree nodes 202 and 204 have heights of 1 and 2, and the additional nodes 203 have heights of 3 and 4. Accordingly, the height of a top node may correspond to 4.

The operation nodes 201 may process the data and may transmit the processed data to a parent node. For example, the operation nodes 201 may process the data according to a predetermined method or a predetermined algorithm. Here, since the data is processed in a parallel structure in each node, the data may be transmitted up to a target height input to the operation node 201. Parent nodes that receive the data from child nodes may perform reduction operation on the data in a predetermined method and may determine a target node to which a reduction result is transmitted, based on the target height received together with the data.

In an example case in which the target height is greater than the height of a current node, the result of the reduction operation may be transmitted to the parent node in the tree structure. Subsequently, the data received from the parent node may be broadcasted to the child nodes.

In another example case in which the target height is less than or equal to the height of the current node, the result of the reduction operation may be transmitted to the child nodes.

According to an embodiment, complexity of connection lines due to the additional nodes 203 may not be high. An ideal amount of communication for communicating one at a time based on the size of the data may be generated by performing reduction operation to the target height required by the operation nodes 201 for the collective communication operation and then performing broadcasting to the operation nodes 201 again.

Accordingly, a plurality of parallel collective communication operations may be performed by the distributed processing apparatus. Hereinafter, the description thereof is provided in detail below.

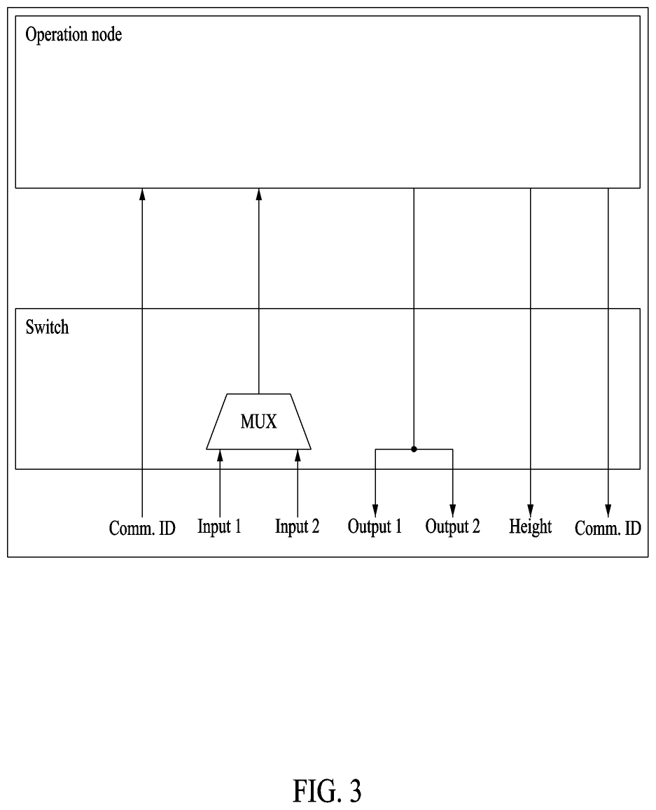

FIGS. 3 to 5 are diagrams illustrating a structure of a node included in a distributed processing apparatus, according to an embodiment. According to an embodiment, each of the node in the distributed processing apparatus may have a structure illustrated in FIGS. 3-5. However, the disclosure is not limited thereto.

FIG. 3 is a diagram illustrating an operation node structure according to an embodiment.

An operation node may be connected to a parent node in a structure through a switch provided for each node. According to an embodiment, the parent node may be referred to as a preceding node.

According to a connection structure shown in FIG. 2, a switch may be provided to connect input/output of the operation node to the parent node. For example, the switch may be provided to connect input/output of the operation node to the parent node in a bidirectional manner (e.g., two directions). According to an embodiment, by connecting in a required direction, an entire bandwidth may be used in an example case in which data is transmitted to the parent node. A collective communication operation may operate at the maximum performance of a bandwidth given to the operation nodes.

In an example case in which a structure does not include the switch, only half the bandwidth may be used when the operational node is connected to the parent node in a bidirectional manner. However, since the collective communication operation on the operation nodes are often not performed simultaneously, the operation nodes may be connected to the parent node through the switch, and as such, a case where divided bandwidths are used simultaneously may be avoided. According to an embodiment, the switch may be a switch of low complexity, such as a 2:1 switch. However, the disclosure is not limited thereto, and as such, other types of switches may be provided.

According to FIG. 3, a communication identification (Comm. ID) processed in the operation node, a target height, and data for which the operation is completed may be transmitted to the parent node through the switch.

In an example case in which a result of reduction from the parent node is broadcasted, a multiplexer (MUX) may confirm which of two groups in orthogonal directions to which the operation node belongs is broadcasting.

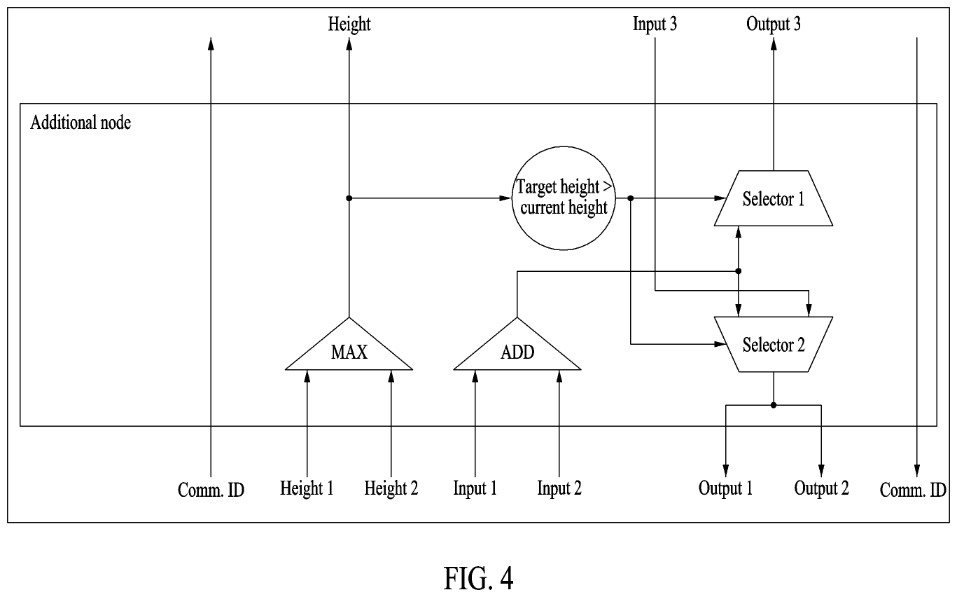

FIG. 4 is a diagram illustrating a structure of additional nodes included in a tree, according to an embodiment.

Depending on a structure of a parallel dimension, the height of an additional node to which data is transmitted from each node may be different, and a target height for distinguishing this may be transmitted from each operation node to the parent node. Until the target height is reached, the results of operations performed at each node (or the results of various reduction operations) may be transmitted to the parent node, and when the additional node corresponding to the target height is reached, the results of reduction performed at the additional node may be broadcast to the child nodes. According to an embodiment, the reduction operation of the embodiment may be assumed to be an addition operation, but the disclosure is not limited thereto. In an example case in which the target height is not a top node, 0 or an arbitrary value (e.g., a meaningless value) may be transmitted to the parent node to prevent calculations from being interrupted in the parent node.

As shown in FIG. 4, data transmitted from the child nodes may be reduced through an add circuit. The direction in which the reduction result is transmitted may be determined by comparing the target height to the height of a current node and transmitting the comparing result to a first selector SEL 1 or a second selector SEL 2. In an example case in which the target height is higher than the height of the current node, a signal may be transmitted to the second selector SEL 2 so that the result of the reduction may be transmitted to the parent node. According to an example embodiment, the second selector SEL 2 may be include a switch. In an example case in which the target height is equal to or lower than the height of the current node, a signal may be transmitted to first selector SEL 1 so that the result of the reduction may be broadcasted to the child nodes. According to an example embodiment, the first selector SEL 1 may be include a MUX.

In an example case in which the result of the reduction is broadcasted to the child nodes, the first selector SEL 1 (e.g., MUX) may confirm a group that receives information corresponding the result of the reduction that is broadcasted.

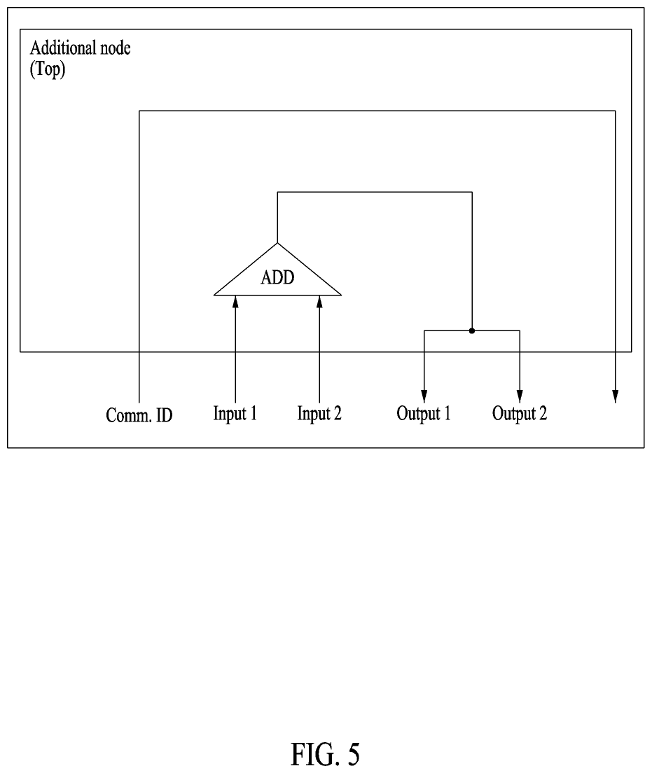

FIG. 5 is a diagram illustrating a structure of the uppermost node among additional nodes, according to an embodiment.

The reduction operation may be performed in a predetermined method on data input from the child nodes, and since the top node does not have a parent node of a current node, the result of the reduction may be broadcasted directly to the child nodes.

As illustrated above, the reduction operation may be configured to enable arithmetic operations such as addition and multiplication or a variety of operations according to data precision or data type. This may be implemented by additionally providing information about which operation is to perform with an operator that supports this.

The diagrams of FIGS. 3 to 5 illustrate functional roles, and depending on distance and scale, the distributed processing apparatus may operate one time with a global clock or synchronously or asynchronously in several stages.

According to an embodiment, the method may not only include one communication within a distributed processing apparatus at a time, but may include additional communication identifications, which may cause synchronization of currently processing communications. The method may further include confirming for which operation the reduction result is obtained in the operation node in which the reduction result is broadcasted.

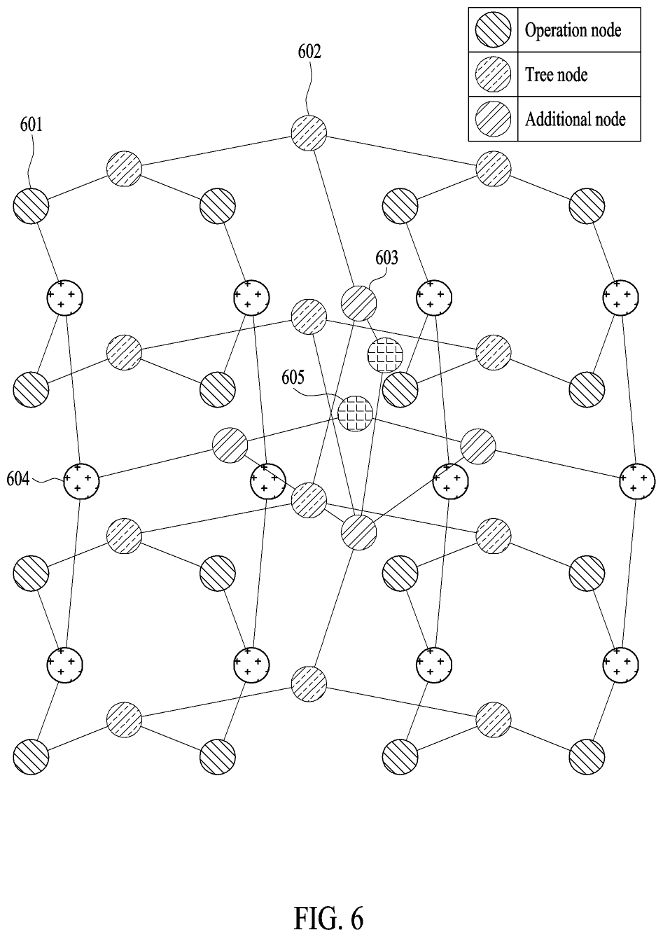

FIG. 6 is a diagram illustrating an expanded form of a connection structure, according to an embodiment.

In a structure of a distributed processing apparatus, as shown in FIG. 2, a form in which the additional nodes 203 are additionally connected to tree nodes of groups in the column direction may be provided.

Referring to FIG. 6, a connection structure that reduces and broadcasts data of all operation nodes 601 in the distributed processing apparatus may be provided by connecting root nodes of first tree nodes 602 that connect each of the groups in the row direction of operation nodes 601 into a tree structure to first additional nodes 603.

In addition, second tree nodes 604 that are connected in a tree structure to each of the groups in the column direction of the operation nodes 601 may be included, and the root nodes among the second tree nodes 604 may be connected to second additional nodes 605. The second additional nodes 605 of the groups in the column direction may communicate in a direction orthogonal to the additional nodes 603 of the groups in the row direction.

In an example case in which more bandwidths at the nodes are to be used in this connection method, a line of trees may be added in another dimension and a distributed processing apparatus that may all-reduce in both directions may operate. Since all-reduce operation in both directions is possible for all nodes, twice the performance for all-reduce may be achieved.

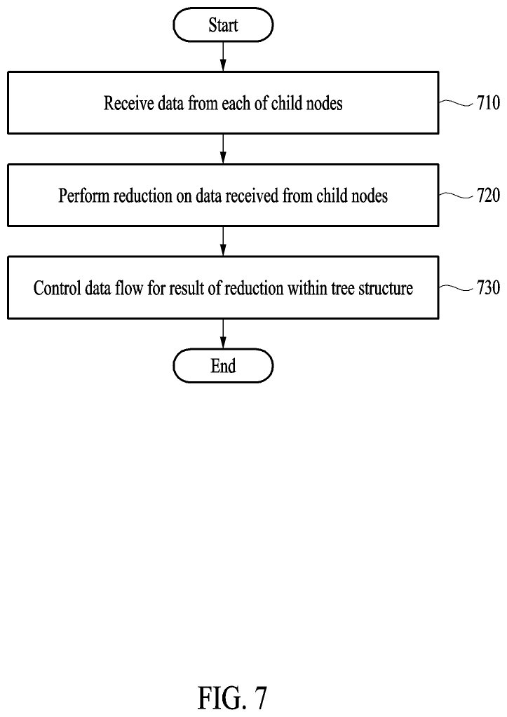

FIG. 7 is a flowchart illustrating a distributed processing method in a distributed processing apparatus, according to an embodiment.

Operations to be described hereinafter may be performed sequentially but not necessarily. For example, the order of the operations may change and at least two of the operations may be performed in parallel. A distributed processing method of a distributed processing apparatus is described herein, and more specifically, operations in additional nodes included in the distributed processing apparatus are described.

The distributed processing apparatus may include a plurality of operation nodes, tree nodes that connect nodes belonging to each of groups, in which a plurality of operation nodes is grouped, in a tree structure, and additional nodes that connect root nodes among the tree nodes in a tree structure. The additional nodes may be connected in an interleaving method of connecting nodes of long distances.

The distributed processing apparatus may perform the distributed processing method through operations 710 to 730.

In operation 710, the method may include receiving data from each of the child nodes. For example, the distributed processing apparatus may receive data from each of the child nodes.

The child nodes may obtain operated data from operation nodes or a result of reduction from intermediate nodes.

In operation 720, the method may include performing a reduction operation on data received from each of the child nodes. For example, the distributed processing apparatus may perform the reduction operation on data received from each of the child nodes.

The reduction operation may be configured to enable arithmetic operations such as addition and multiplication or a variety of operations according to data precision or data type. The reduction operation may include at least one of an arithmetic operation, a statistical operation, a counting operation, or a logical operation, according to data precision and data type.

In operation 730, the method may include controlling a data flow for the result of reduction within a tree structure by referring to a target height for the reduction operation. For example, the distributed processing apparatus may control the data flow for the result of reduction within the tree structure by referring to a target height for the reduction.

The height of an additional node to which data is transmitted from each node of the distributed processing apparatus may be different, and a target height for distinguishing this may be transmitted from each operation node to the parent node. Until the target height is reached, the results of reduction operations performed at each node may be transmitted to the parent node, and based on the additional node corresponding to the target height being reached, the results of reduction performed at the additional node may be broadcast to the child nodes.

Accordingly, the distributed processing apparatus may compare the received target height to the height of the current node. That is, in an example case in which the target height is higher than the height of the current node, the result of the reduction of the received data may be transmitted to the parent node of the current node, and in an example case in which the target height is equal to or lower than the height of the current node, the result of the reduction may be transmitted to the child node. When transmitting the result of the reduction to the parent node, a signal regarding the target height may be transmitted together.

Accordingly, a plurality of parallel collective communication operations may be performed by the distributed processing apparatus.

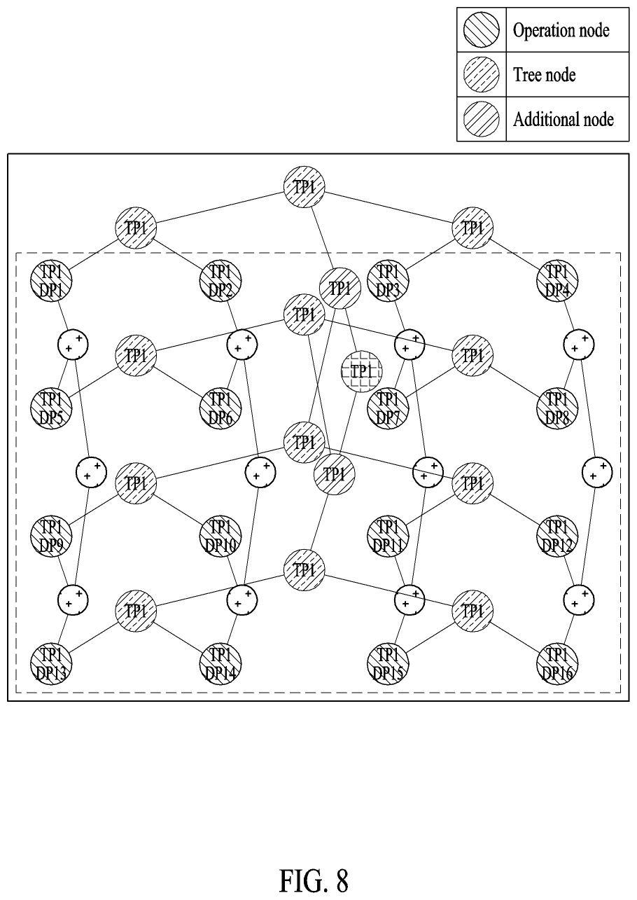

FIGS. 8 to 11 are diagrams illustrating examples of communication paths in a distributed processing apparatus, according to an embodiment.

Each path in which collective communication operations are performed is shown for operations that have different sizes individually in multiple dimensions. In various embodiments, communication may be achieved through a mode-optimal connection path.

For each group of the distributed processing apparatus, a row group may be expressed as a data-parallelism (DP) group, a column group may be expressed as a tensor-parallelism (TP) group, and a group index in the diagram may be referenced. According to an embodiment, weight gradient all-reduce may be performed between each DP group, and activation all-reduce may be performed between each TP group. Here, since each all-reduce is only performed within the same group, when connecting additional nodes, a tree structure may be added by connecting nodes first that are far apart.

According to FIG. 8, operations for all-reduce are described in a distributed processing environment where the DP group includes “16” groups and the TP group includes “1” group.

FIG. 8 shows an environment where activation all-reduce is not practically performed because there is only one TP group, and a connection with the TP group is required for weight gradient all-reduce in the DP group. To this end, all-reduce may be performed and broadcasted in the tree structure by the additional nodes of the TP group. According to FIG. 8, a reduction of an interleaving dimension in the additional nodes may not be essential.

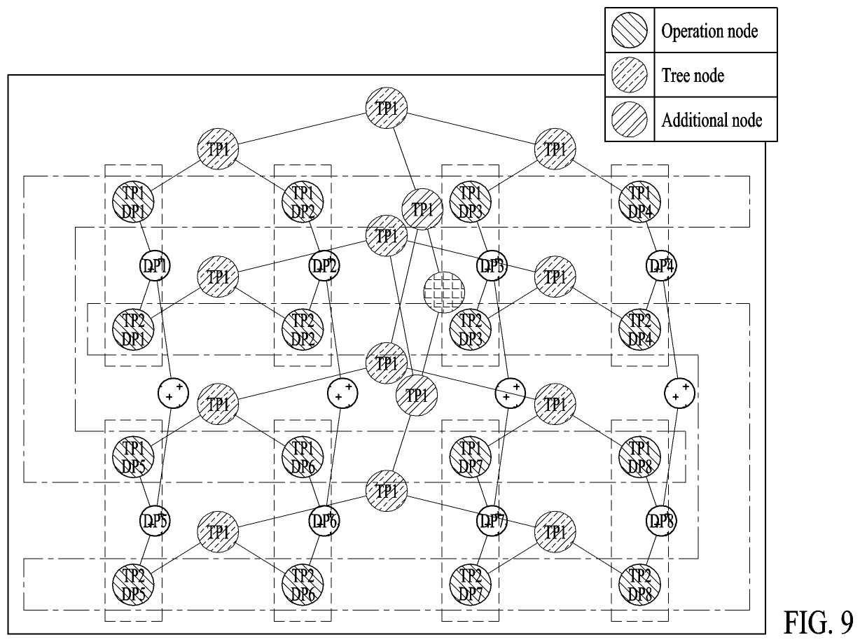

FIG. 9 is a diagram illustrating an example in which all-reduce is processed into “8” DP groups and “2” TP groups.

The DP groups are formed between nodes that are close to each other in the column direction, and the same TP groups may need to be connected to perform weight gradient all-reduce between the DP groups. Therefore, reduction may need to be performed in the structure of the TP group and in the interleaving dimension. There may be no congestion in performing required collective communication operation.

For example, in the interleaving method, connecting has an advantage that communication between the same indices is useful when the TP/DP indices are sequential. Referring to FIG. 9, when an upper node is sequentially referred to as 1 (TP1) and a lower node as 2 (TP2) among nodes such as DP1 to DP5, an interleaving structure may be useful for connecting the upper nodes 1 and the lower nodes 2, separately.

According to embodiments of FIG. 9, the target height may be 3, and the result of reduction in an additional node of height 3 may be broadcasted to child nodes.

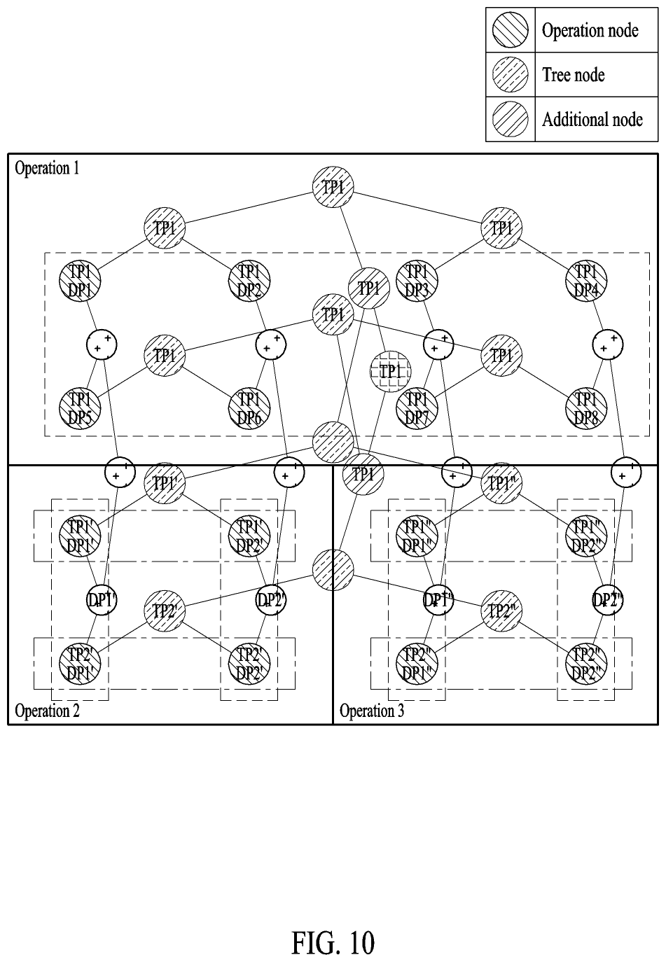

FIG. 10 shows an example of three collective communication operations, in which operation 1 uses eight DP groups and one TP group and operations 2 and 3 use two DP groups and two TP groups, respectively.

Operations 2 and 3 may both have the form in which all-reduce is not required because the DP groups are connected to each other through the TP groups and the TP groups are connected through the DP groups.

In operation 1, the same TP group may need to be connected to perform weight gradient all-reduce between the DP groups. For the weight gradient all-reduce of operation 1, a collective communication operation may be executed with a target height of 4.

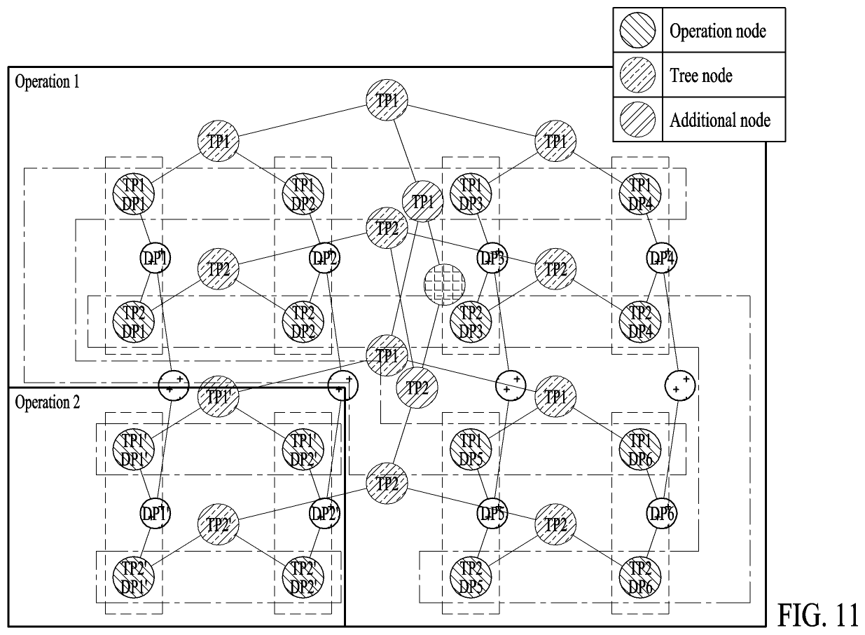

FIG. 11 shows an example of two collective communication operations, in which operation 1 uses six DP groups and two TP group and operation 2 uses two DP groups and two TP groups.

In an example case in which multiple collective communication operations are processed in the distributed processing apparatus, congestion-free reduction and broadcasting may be achieved through the illustrated connection structure. Depending on the size of the collective communication operation, the operation nodes may be divided and grouped in various proportions. In addition, parallelism coefficients of workloads may be supported in various forms.

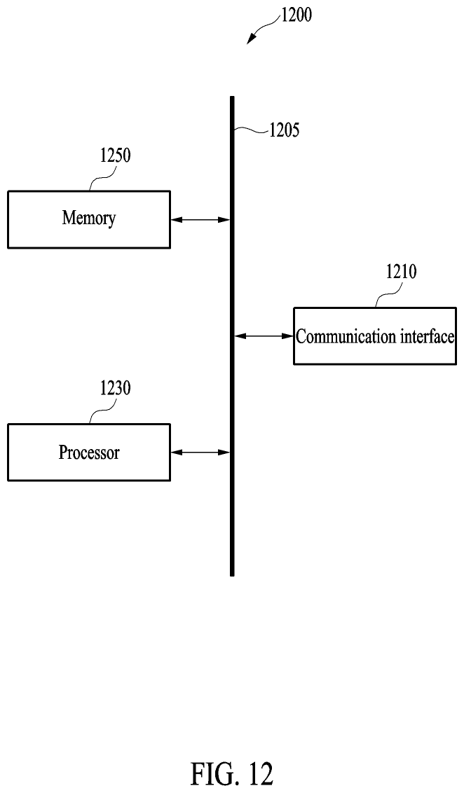

FIG. 12 is a block diagram illustrating a node of a distributed processing apparatus, according to an embodiment.

Referring to FIG. 12, a distributed processing apparatus 1200 may include a communication interface 1210, a processor 1230, and a memory 1250. The communication interface 1210, the processor 1230, and the memory 1250 may communicate with each other through a communication bus 1205. However, the disclosure is not limited thereto, and as such, according to an embodiment, the distributed processing apparatus 1200 may include one or more other components.

The communication interface 1210 may receive data and a target height from child nodes. In addition, a result of reduction may be transmitted to a parent node or the child node, based on a result of comparing the height of a current node and the received target height.

The processor 1230 may perform reduction on data received through the communication interface 1210. The processor 1230 may perform reduction on data in a predetermined method and may determine a target node to which the result of the reduction is transmitted. By comparing the height of the current node to the received target height, based on the target height being greater, the result of the reduction may be transmitted to the parent node, and based on the height of the current node being equal to or greater than the target height, the result of the reduction may be determined to be broadcasted to the child node.

The memory 1250 may store a variety of information generated in the processing process of the processor 1230 described above. In addition, the memory 1250 may store various types of data, programs, software code or instructions. The memory 1250 may include a volatile memory or a non-volatile memory. The memory 1250 may store a variety of data by including a large mass storage medium, such as a hard disc.

In addition, the processor 1230 may perform at least one of the methods described with reference to FIGS. 1 through 11 or an algorithm corresponding to at least one of the methods. The processor 1230 may be a data processing apparatus implemented by hardware including a circuit having a physical structure to perform desired operations. For example, the desired operations may include code or instructions in a program. The processor 1230 may be implemented as, for example, a central processing unit (CPU), a graphics processing unit (GPU), or a neural network processing unit (NPU). For example, the hardware-implemented distributed processing apparatus 1200 may include a microprocessor, a CPU, a processor core, a multi-core processor, a multiprocessor, an application-specific integrated circuit (ASIC), and a field-programmable gate array (FPGA).

The processor 1230 may execute a program and control the distributed processing apparatus 1200. Code of the program executed by the processor 1230 may be stored in the memory 1250.

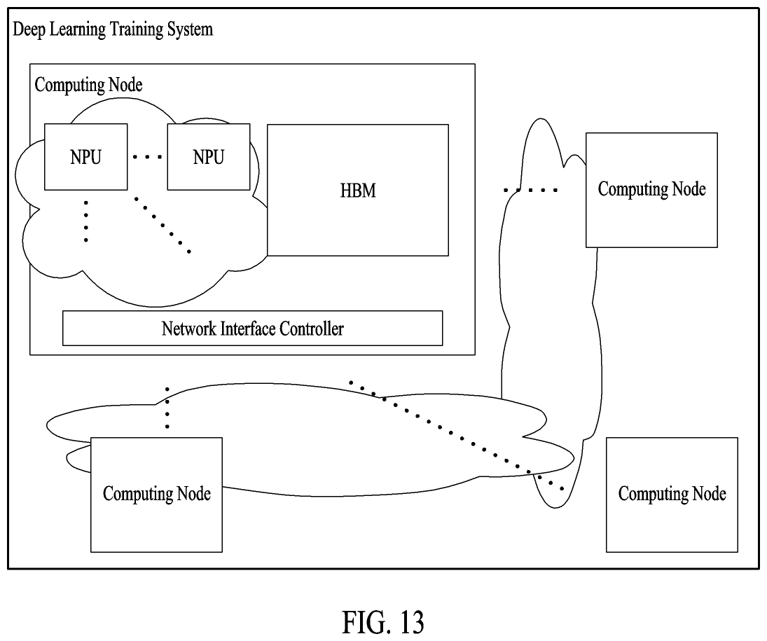

FIG. 13 illustrates an example of an application to a hierarchical structure, according to an embodiment.

A connection structure of the distributed processing apparatus may be utilized in the design of various components such as an NPU and a high bandwidth memory (HBM). The connection structure described above may be applied in different forms depending on the physical characteristics and scale advantages at various layers.

The connection structure may be applied to connections between operational circuits and may also be applied to connections between chips or connection structures between nodes. Some of the connection structures may also be utilized in combination with other connection structures.

In FIG. 13, the connection nodes that perform the role of connecting a network between nodes and also between NPUs may have the same tree structure as in the embodiment.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or rearranged or supplemented by other components or their equivalents.

Therefore, other implementations, other embodiments, and equivalents to the claims are also within the scope of the following claims.

What is claimed is:

1. A distributed processing apparatus comprising:
a plurality of operation nodes grouped into a plurality of first groups;
a plurality of first tree nodes configured to connect operation nodes, among the plurality of operation nodes, belonging to each of the plurality of first groups; and
a plurality of first additional nodes configured to connect root nodes of the plurality of first groups,
wherein, in a first tree structure comprising the plurality of first additional nodes and the plurality of first tree nodes, a first intermediate node is configured to:
perform a reduction operation on data received from child nodes in the first tree structure, and
control a data flow of a result of the reduction operation within the first tree structure, according to a first target height received from the child nodes in the first tree structure.

2. The distributed processing apparatus of claim 1, wherein
the reduction operation comprises at least one of an arithmetic operation, a statistical operation, a count operation, or a logical operation, according to data precision and a data type.

3. The distributed processing apparatus of claim 1, wherein,
based on the first target height being greater than a height of the first intermediate node in the first tree structure, the first intermediate node is configured to transmit the result of the reduction operation to a parent node in the first tree structure and broadcast data received from the parent node to the child nodes in the first tree structure.

4. The distributed processing apparatus of claim 1, wherein,
based on the first target height being less than or equal to a height of the first intermediate node in the first tree structure, the first intermediate node is configured to broadcast the result of the reduction operation to the child nodes in the first tree structure.

5. The distributed processing apparatus of claim 1,
wherein the plurality of operation nodes is grouped into a plurality of second groups, and
wherein the distributed processing apparatus further comprises:
a plurality of second tree nodes configured to connect operation nodes, the plurality of operation nodes, belonging to each of the plurality of second groups.

6. The distributed processing apparatus of claim 5, wherein
the plurality of first groups are configured based on grouping the plurality of operation nodes in a first direction, and the plurality of second groups are configured based on grouping the plurality of operation nodes in a second direction orthogonal to the first direction.

7. The distributed processing apparatus of claim 5, wherein
each of the plurality of operation nodes is configured to transmit data to the plurality of first tree nodes through a 2-to-1 connection switch.

8. The distributed processing apparatus of claim 5, further comprising:
a plurality of second additional nodes configured to connect root nodes of the plurality of second groups,
wherein, in a second tree structure comprising the plurality of second additional nodes and the plurality of second tree nodes, a second intermediate node is configured to:
perform a reduction operation on data received from child nodes in the second tree structure, and
control a data flow of a result of the reduction operation within the second tree structure, according to a second target height received from the child nodes in the second tree structure.

9. The distributed processing apparatus of claim 8, wherein
the first tree structure and the second tree structure have independent connection structures.

10. A distributed processing method of a distributed processing apparatus, the distributed processing method comprising:
receiving pieces of data from each of a plurality of child nodes in a first tree structure;
performing a reduction operation on the pieces of data received from the plurality of child nodes; and
controlling a data flow of a result of the reduction operation within a first tree structure based on a target height corresponding to the reduction operation,
wherein the first tree structure comprises:
a plurality of tree nodes configured to connect a plurality of nodes belonging to each of a plurality of groups, in which a plurality of operation nodes of the distributed processing apparatus is grouped, in a second tree structure; and
additional nodes configured to connect root nodes among the plurality of tree nodes in a third tree structure.

11. The distributed processing method of claim 10, wherein
the controlling of the data flow of the result of the reduction operation within the first tree structure comprises transmitting the result of the reduction operation to one of the plurality of child nodes or a parent node, based on the target height.

12. The distributed processing method of claim 10, wherein
the receiving of the pieces of data from each of the plurality of child nodes comprises receiving an operation result of each of the plurality of child nodes and the target height.

13. A non-transitory computer-readable storage medium storing instructions that, when executed by a processor, cause the processor to perform a method of a distributed processing apparatus comprising:
receiving pieces of data from each of a plurality of child nodes in a first tree structure;
performing a reduction operation on the pieces of data received from the plurality of child nodes; and
controlling a data flow of a result of the reduction operation within a first tree structure based on a target height corresponding to the reduction operation,
wherein the first tree structure comprises:
a plurality of tree nodes configured to connect a plurality of nodes belonging to each of a plurality of groups, in which a plurality of operation nodes of the distributed processing apparatus is grouped, in a second tree structure; and
additional nodes configured to connect root nodes among the plurality of tree nodes in a third tree structure.
